(19) United States
(12) Patent Application Publication
(10) Pub. No.: US 2026/0159651 A1
(43) Pub. Date: Jun. 11, 2026

(54) AN ARTICLE MADE FROM AN ELASTOMERIC POLYMER COMPOSITION

(71) Applicant: Dow Global Technologies LLC, Midland, MI (US)

(72) Inventors: Guangming Li, Sugar Land, TX (US); Xiaosong Wu, Sugar Land, TX (US); Mark T. Jablonka, Pearland, TX (US); Hayley A. Brown, Houston, TX (US); Paul J. Brigandi, Wayne, PA (US); Jeffrey M. Cogen, Flemington, NJ (US); Bharat I. Chaudhary, Princeton, NJ (US); Xi Chen, Shanghai (CN)

(21) Appl. No.: 18/707,239

(22) PCT Filed: Jan. 19, 2023
(86) PCT No.: PCT/US2023/060885

§ 371 Date: May 3, 2024

Related U.S. Application Data
(60) Provisional application No. 63/267,083, filed on Jan. 24, 2022.

(51) Int. Cl. C08J 3/20; B29C 43/00; B29C 45/00; B29C 48/00; B29K 83/00; B29L 23/00; B29L 29/00; B29L 31/26; C08K 5/5415

(52) U.S. Cl. CPC C08J 3/20; B29C 43/003; B29C 45/0001; B29C 48/022; C08K 5/5415; B29K 2083/00; B29L 2023/005; B29L 2029/00; B29L 2031/26; C08J 2343/04

(57) ABSTRACT

A profile or article formed from a moisture- and/or thermo-curable elastomeric polymer composition including: (A) at least one ethylene-olefinic monomer-silane polymer; wherein the at least one ethylene-olefinic monomer-silane polymer has a melt index of from 0.1 gram/10 minutes to 10.0 grams/10 minutes; and wherein the at least one ethylene-olefinic monomer-silane polymer has an enthalpy of fusion of less than 85 J/g; and (B) at least one silanol condensation catalyst; a shaped article made from the above elastomeric polymer composition; and a method of making a shaped article using the above elastomeric polymer composition.

### FIELD

The present invention relates to an article or profile comprising an elastomeric polymer composition, and more specifically, the present invention relates to an article or profile comprising a moisture-curable and/or a thermo-curable elastomeric polymer composition useful for producing automotive articles and parts such as automotive weather seals and automotive hoses.

### BACKGROUND

Flexible ethylene propylene diene monomer (EPDM) rubber is used for manufacturing, for example, automobile weatherstrips and coolant hoses. Automotive weatherstrips or weather seals are typically mounted on automobile doors along the perimeter of the doors and on the automobile body to provide a seal between the automobile doors and automobile body when the automobile doors and automobile body come in contact with each other. The functionalities of automotive weather seals include, but are not limited to, for example reducing wind noise; providing air and water seal; and preventing dust and foreign material from entering the automobile.

Typically, automotive weather seals are made with fully vulcanized EPDM profiles or extruded thermoplastic vulcanizates (TPVs) profiles. TPVs represent a relatively low manufacturing cost solution, but the performance of TPVs is limited due to the TPVs' high hardness property and poor long-term dynamic sealing property. While vulcanized EPDM parts provide good static and dynamic sealing performance, the vulcanized EPDM parts often suffer from, for example: (1) surface discolorations after aging which are perceived as poor UV weatherability; (2) poor long-term compression set which causes an inferior long-term noise, vibration, and harshness (NVH) property; and (3) poor performance of automobile cabin noise reduction. The manufacturing process and cost associated with EDPM weather seals production are typically complex and expensive due to, for example: (1) complex compound batch mixing of the composition; (2) extrusion of the composition; and (3) the required long period of time for the several curing steps for curing the composition.

Automotive coolant hoses are used to transfer aqueous coolant containing corrosion inhibitors under pressure conditions at continuous temperatures ranging from −40° C. to 150° C. A third of the heat energy produced by an internal combustion engine ends up as waste heat in the cooling system. Therefore, EPDM coolant hoses (for example, upper radiator hose, lower radiator hose, and heater hoses) are the most critical parts in the entire engine cooling system of an automobile. Long-term high temperature resistance is considered the most important property for automotive coolant EPDM hoses. An EPDM rubber hose formula usually contains reinforcing fillers, extending fillers, process oils, stabilizers, curatives, and other additives; and mixing the above ingredients with an EPDM rubber is a critical step in the overall EPDM hose manufacturing process because a homogenous and well-mixed compound is required for consistent rubber compound properties.

Thermoset EPDM rubber coolant hoses for automotive thermal management systems also have undergone dramatic changes over the past decade. The compact and sophisticated engine designs for internal combustion engine (ICE) vehicles have led to increased temperature environments and durability requirements for automotive parts under the hood compartments (for example, under-the-hood coolant hoses, and wire-and-cable components). Improving the continuous, upper temperature resistance of a thermoset rubber is a challenging task due to more stringent design criteria needed to meet the increased temperature environments and durability requirements of ICE. Industrial applications have followed similar trends, involving requirements for higher service temperatures and extended service life periods of rubber articles. Consequently, many automotive and industrial applications now require rubber formulations that have high temperature performance and long-term heat and weather resistance.

In addition, the technology development trend in the automotive industry constantly focuses on the next generation of automotive sealing systems and thermal management systems which offer, for example: (1) a lower part density or weight, (2) a lower electrical conductivity, (3) a lower volatile organic compound (VOC) level for reduced fogging, and (4) better long-term heat and weather resistance properties.

U.S. Pat. No. 10,040,888B1 mentions a weather seal formulation comprising a silane grafted polyolefin which is different from conventional weather seal formulations comprising EPDM or TPV. The process of manufacturing the weather seal composition of the above patent includes reactive extrusion, extrusion, molding, and curing. Advantages for the proposed composition comprising the silane grafted polyolefins of the above patent include the following: (1) the formulation of the above patent uses less ingredients; and it is easy to compound all of the ingredients in a simple extrusion step without using complicated traditional rubber internal mixing equipment; (2) the formulation of the above patent exhibits superior stress/strain behavior compared to conventional EPDM materials; (3) the formulation of the above patent reduces the carbon footprint of an extrusion plant due to the elimination of the vulcanization process (e.g., a process using a hot air/microwave oven or an autoclave); and (4) the formulation of the above patent comprising the silane-grafted and crosslinked polyolefin has a lower specific gravity compared to TPV formulations and EPDM formulations. The manufacture of parts, using the formulation of the above patent having a reduced specific gravity, leads to the capability of manufacturing parts having a lower weight compared to parts made from conventional formulations, thereby helping automakers meet increasing demands for automobiles having an improved fuel economy.

U.S. Pat. No. 10,253,127B2 mentions a weatherstrip composition comprising a silane grafted polyolefin which is different from conventional weatherstrip formulations comprising EPDM or TPV. And, the composition of the above patent includes a silane grafted polyolefin and one or more additives (e.g., polypropylene (PP), TPV, olefin block copolymer (OBC), EPDM, ethyl vinyl acetate (EVA), ethylene-butyl acrylate (EBAC) copolymers, and ethylene methacrylate (EMA) copolymers. The above patent also mentions that the manufacturing process of the above patent includes reactive extrusion, extrusion, molding, and curing.

U.S. Pat. No. 10,774,168B2 mentions windshield wiper formulations with silane grafted polyolefin which are different from conventional weatherstrip formulations with EPDM or TPV. The composition of the above patent includes a silane grafted polyolefin and one or more additives (e.g., PP, TPV, OBC, EPDM, EVA, EBAC copolymers, and EMA copolymers); and the manufacturing process mentioned in the above patent involves reactive extrusion, extrusion, molding, and curing.

U.S. Pat. No. 10,100,139B2 mentions a hose composition containing silane grafted polyolefin; and a manufacturing process which involves reactive extrusion, extrusion, molding, and curing.

U.S. Pat. No. 6,624,254B1 mentions silane functionalized olefin interpolymer derivatives. In the above patent, the silane functional polymers have a uniform silane distribution, a long chain branching and/or a tertiary silane functionality. The conversion process disclosed in the above patent is conducted through coupling, hydrolysis, hydrolysis and neutralization, condensation, oxidation or hydrosilylation.

U.S. Pat. No. 6,667,098B1 mentions a moisture curable ethylene-alkyl (meth)acrylate vinyl trialkoxysilane terpolymer composition used for manufacturing an insulating and jacketing layer for electrical rubber cable. The alkyl (meth)acrylate comonomer comprises more than 5 mol % in the terpolymer composition; and the trialkoxysilane termonomer comprises from 0.2% to 5% by weight of the terpolymer composition. The total polymer composition disclosed in the above patent for fabricating an insulating and jacketing layer may include from 0% up to 50% by weight of a plasticizer, up to 60% by weight of a filler, and up to 10% by weight of another additive.

Nothing in the above prior art references mentions an elastomeric polymer composition specifically curable with moisture and more specifically useful for producing automotive articles and parts such as automotive hoses and automotive weather seals. Also, automotive original equipment manufacturers (OEMs) strongly desire a better alternative solution and a replacement for various currently used elastomeric products such as EPDM and TPV.

Therefore, it is desired to provide an elastomeric polymer composition for use in automobile applications, for example for use by automotive OEMs in the automobile industry; and for use in wire and cable applications.

### SUMMARY

In one embodiment, the present invention is directed to a profile or article comprising a moisture-curable elastomeric polymer composition and/or a thermo-curable elastomeric polymer composition comprising a mixture, admixture, or blend of:
(A) at least one ethylene-olefinic monomer-silane polymer such as a terpolymer or a tetrapolymer; wherein the at least one ethylene-olefinic monomer-silane polymer has a melt index of from 0.1 gram/10 minutes to 10.0 grams/10 minutes; and wherein the at least one ethylene-olefinic monomer-silane polymer has an enthalpy of fusion of less than 85 J/g; and
(B) at least one curing catalyst that advances moisture-curing and/or thermo-curing of the elastomeric polymer composition.

In one embodiment, the at least one ethylene-olefinic monomer-silane polymer, component (A) of the above moisture- and/or thermo-curable elastomeric polymer composition, includes, for example, an ethylene-ethyl acrylate-silane terpolymer or tetrapolymer.

In another embodiment, the at least one curing catalyst, component (B) of the above moisture- and/or thermo-curable elastomeric polymer composition, includes, for example, at least one silanol condensation catalyst.

In another embodiment, the present invention is directed to a process for preparing a profile or article comprising the above moisture- and/or thermo-curable elastomeric polymer composition.

The above moisture- and/or thermo-curable elastomeric polymer composition is useful for a variety of applications, and, more specifically, for automotive applications. For example, in other embodiments, the above moisture- and/or thermo-curable elastomeric polymer composition includes a weather seal, a hose, a belt, or a profile composition.

In still another embodiment, the present invention is directed to a process for manufacturing a weather seal, a hose, a belt, or a profile product comprising the steps of:
(I) providing: (A) at least one ethylene-olefinic monomer-silane polymer; and (B) at least one curing catalyst that advances moisture-curing and/or thermo-curing of an elastomeric polymer composition;
(II) mixing or compounding: (A) the at least one ethylene-olefinic monomer-silane polymer; and (B) the at least one curing catalyst that advances moisture-curing and/or thermo-curing of an elastomeric polymer composition from step (I) to form a moisture-curable and/or thermo-curable elastomeric polymer composition;
(III) extruding the elastomeric polymer composition from step (II);
(IV) molding the extruded elastomeric polymer composition from step (III) into a shape of a finished part or article; and
(V) exposing the finished part or article from step (IV) to humidity and/or heat to cure the finish part or article from step (IV).

In some embodiments, the mixing or compounding step (II) of the above process is carried out using traditional mixing or compounding equipment, for example, a roll mill, an internal mixer, a single-screw extruder, or a twin-screw compounding extruder. In other embodiments, in step (II) of the above process, the at least one ethylene-olefinic monomer-silane polymer, component (A) of the above moisture- and/or thermo-curable elastomeric polymer composition, includes, for example, an ethylene-ethyl acrylate-silane terpolymer or tetrapolymer. In still other embodiments, in step (II) of the above process, the curing catalyst, component (B) of the above moisture- and/or thermo-curable elastomeric polymer composition, includes, for example, at least one silanol condensation catalyst.

In step (IV) of the above process, the ethylene-ethyl acrylate-silane terpolymer or tetrapolymer and a silanol condensation catalyst composition is molded into the shape of a finished part or article, for example, a weather seal, a hose, a belt, a profile article, and the like.

In another preferred embodiment, the article is a weather seal, a hose, a belt, or profile article manufactured by the above process.

The present invention develops a technical solution for various crosslinked/thermoset automotive parts which does not require a traditional sulfur cure step or a peroxide cure step. The fully formulated compound exhibits a required compound hardness and can be fully vulcanized via, for example, a moisture curing process. Therefore, a significant manufacturing cost saving can be achieved in comparison to traditional sulfur and peroxide cured EPDM systems. Inherently, the moisture cured crosslinked network that forms the profile or article of the present invention imparts superior color stability, long-term high heat resistance, long-term weatherability, and long-term sealing performance to the profile or article.

### DETAILED DESCRIPTION

Temperatures used herein are in degrees Celsius (C).

“Room temperature (RT)” herein means a temperature between 20° C. and 26° C., unless specified otherwise.

“Ambient temperature” herein means the temperature of the environment that exists without application of heating or cooling systems specifically for the purpose of accelerating moisture crosslinking. In one general embodiment, the ambient temperature contemplated in this disclosure can be, for example, from 0° C. to 50° C.

“Ambient humidity” herein means the humidity of the environment that exists without application of technology specifically for the purpose of accelerating moisture crosslinking. In one general embodiment, the ambient humidity contemplated in this disclosure can be, for example, from 5% to 100%.

The phrase “ambient conditions” refers to the temperature and humidity of the environment that exists without application of technology to provide heating, cooling, or moisture specifically for the purpose of accelerating moisture crosslinking. The term “ambient conditions,” in one embodiment, is an air atmosphere with a temperature from 0° C. to 50° C. and a relative humidity from 5% to 100%.

“Vulcanization” herein means formation of a three-dimensional crosslinked (cured) network.

The term “composition,” as used herein, refers to a mixture of materials which comprises the composition, as well as reaction products and decomposition products formed from the materials of the composition.

An “elastomer” or “elastomeric material” or “elastomeric polymer” herein means a polymer having elastic properties and which is capable of recovering its original shape after being stretched to great extents.

The phrase “moisture-curable elastomeric polymer composition” herein means an elastomeric polymer composition that can be chemically crosslinked by reaction with water, where the alkoxysilane reacts with water in a hydrolysis step to form silanol. The condensation of neighboring silanol groups in the elastomeric polymer composition forms a siloxane linkage, leading to three-dimensionally crosslinked networks.

A “terpolymer” is a polymer (such as a complex resin) that results from copolymerization of three discrete monomers (or co-monomers).

A “tetrapolymer” is a polymer (such as a complex resin) that results from copolymerization of four discrete monomers (or co-monomers).

A “condensation catalyst” is a catalyst that accelerates the alkoxysilane hydrolysis reaction and/or the silanol condensation reaction to form siloxane crosslinks.

“Long-term,” with reference to a property such as a “long-term heat resistance property,” a “long-term weatherability property”, a “long-term dynamic sealing property”, a “long-term compression set property”, and a “long-term noise, vibration and harshness (NVH) property”, herein means longer than one month.

The terms “comprising,” “including,” “having,” and their derivatives, are not intended to exclude the presence of any additional component, step, or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “@” means “at”; the meaning of “and/or” includes the term “and” and alternatively the term “or”; ppm=parts per million; ppb=parts per billion; ppt=parts per trillion; BV/hr=bed volume/hour(s); “MT”=metric ton(s); g=gram(s); mg=milligram(s); Kg=kilogram(s); J/g=Joules per gram; L=liters; g/L=gram(s) per liter; μL=microliter(s); “g/cm³” or “g/cc”=gram(s) per cubic centimeter; g/10 min=gram(s) per 10 minutes; mg/mL=milligrams per milliliter; “kg/m³=kilogram(s) per cubic meter; ppm=parts per million by weight; pbw=parts by weight; rpm=revolutions per minute; m=meter(s); mm=millimeter(s); cm=centimeter(s); μm=micron(s) or micrometer(s); nm=nanometer(s); min=minute(s); s'2 second(s); ms=millisecond(s); hr=hour(s); Pa=pascals; MPa=megapascals; Pa-s=Pascal second(s); mPa-s=millipascal second(s); g/mol=gram(s) per mole(s); g/eq=gram(s) per equivalent(s); Mₙ=number average molecular weight; M_{w}=weight average molecular weight; pts=part(s) by weight; 1/s or sec⁻¹=reciprocal second(s) [s⁻¹]; ° C.=degree(s) Celsius; ° C./min=degree(s) Celsius per minute; psi=pounds per square inch; kPa=kilopascal(s); %=percent; vol %=volume percent; mol %=mole percent; and wt %=weight percent.

Specific embodiments of the present invention are described herein below. These embodiments are provided so that this disclosure is thorough and complete; and fully conveys the scope of the subject matter of the present invention to those skilled in the art.

Unless stated to the contrary, implicit from the context, or customary in the art, all percentages, parts, ratios, and the like amounts are based on weight, all temperatures are in ° C., and all test methods are current as of the filing date of this disclosure.

Generally, the elastomeric polymer composition described in this disclosure is useful for preparing, for example, automotive parts/articles/profiles; and the elastomeric polymer composition useful in the present invention includes: (A) at least one ethylene-olefinic monomer-silane polymer; and (B) at least one curing catalyst. Other optional additives or agents, or compounds, optional component (C), can be added to the above elastomeric polymer composition, if desired.

In some embodiments, the ethylene-olefinic monomer-silane polymer, component (A), can include a terpolymer. Alternatively, in other embodiments, component (A) can include a tetrapolymer. In some embodiments, component (A) is selected from one or more tetrapolymers such as ethylene-alkyl (meth)acrylate-silane, ethylene-glycidyl (meth)acrylate-silane, ethylene-maleic anhydride-alkyl (methacrylate) silane, ethylene-glycidyl (meth)acrylate-alkyl (meth)acrylate-silane, ethylene-vinyl acetate-silane, ethylene-alkyl (meth)acrylate-vinyl acetate-silane, ethylene-carbon monoxide-silane, ethylene-alkyl (meth)acrylate-carbon monoxide-silane, and mixtures thereof. In a preferred embodiment, component (A) is a terpolymer such as ethylene-olefinic monomer-silane terpolymer.

In one embodiment, the at least one ethylene-olefinic monomer-silane terpolymer, component (A), can be an ethylene-alkyl (meth)acrylate-silane terpolymer. The olefinic monomer component of the terpolymer can be an alkyl (meth)acrylate monomer and the alkyl (meth)acrylate monomer can be represented by the general formula CH²:C(R1)CO₂(R2). In the general formula, R1 is hydrogen or hydrocarbon group having 1 carbon atom to 10 carbon atoms which may have branch, ring and/or unsaturated bond. R2 is hydrocarbon group having 1 carbon atom to 30 carbon atoms, which may have branch, ring and/or unsaturated bond. When the carbon number of R1 is larger than 11, polymerization activity tends to be suppressed. Therefore, R1 is a hydrogen or a hydrocarbon group having 1 to 10 carbon atoms; and in one preferred embodiment, the alkyl (methacrylate) monomer component includes, for example, (meth)acrylate in which R1 is hydrogen or a hydrocarbon group having from 1 carbon atom to 5 carbon atoms. In another preferred embodiment, the alkyl (meth)acrylate includes (meth)acrylate in which R1 is a methyl group or an acrylate in which R1 is hydrogen. Similarly, when the carbon number of R2 is larger than 30, polymerization activity tends to be suppressed. Therefore, the carbon number of R2 is from 1 to 30 in one general embodiment, from 1 to 12 in another embodiment, and from 1 to 8 in still another embodiment.

The alkyl (meth)acrylate monomer useful in the ethylene-olefinic monomer-silane terpolymer for preparing the elastomeric polymer composition includes, for example, methyl(meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, pentyl (meth)acrylate, hexyl (meth)acrylate, cyclohexyl (meth)acrylate, octyl (meth)acrylate, 2-ethylhexyl (meth)acrylate, nonyl (meth)acrylate, decyl (meth)acrylate, dodecyl (meth)acrylate, phenyl (meth)acrylate, toluoyl (meth)acrylate, benzyl (meth)acrylate, and mixtures thereof. Additional comonomers of use include heteroatom containing olefinic monomers including vinyl acetate, maleic anhydride, glycidyl (meth)acrylate, carbon monoxide, hydroxyethyl (meth)acrylate, 1-aminopropyl (meth)acrylate, 2-aminopropyl (meth)acrylate, 3-aminopropyl (meth)acrylate, and mixtures thereof.

Exemplary of the ethylene-alkyl (meth)acrylate-silane terpolymers, component (A), include: an ethylene-ethyl (meth)acrylate-silane terpolymer, ethylene-methyl acrylate-silane terpolymers, ethylene-ethyl acrylate-silane terpolymers, ethylene-propyl acrylate-silane terpolymers, ethylene-butyl acrylate-silane terpolymers, and mixtures thereof.

In one preferred embodiment, component (A) of the elastomeric polymer composition comprises, consists essentially of, or consists of: an ethylene-methyl (meth)acrylate-silane terpolymer, ethylene-ethyl acrylate-silane terpolymers, ethylene-butyl acrylate-silane terpolymers, and mixtures thereof.

In other embodiments, the olefinic monomer component of the at least one ethylene-olefinic monomer-silane terpolymer useful in the present invention, component (A), can be, for example, ethylene-methyl acrylate-silane terpolymer, ethylene-ethyl acrylate-silane terpolymer, ethylene-propyl acrylate-silane terpolymer, ethylene-n-butyl acrylate-silane terpolymer, ethylene-i-butyl acrylate-silane terpolymer, ethylene-2-ethyl hexyl acrylate-silane terpolymer, ethylene-isobornyl acrylate-silane terpolymer, ethylene-pentyl acrylate-silane terpolymer, ethylene-hexyl acrylate-silane terpolymersor ethylene-octyl acrylate-silane terpolymers ethylene-methyl methacrylate-silane terpolymer, ethylene-ethyl methacrylate-silane terpolymer, ethylene-propyl methacrylate-silane terpolymer, ethylene-n-butyl methacrylate-silane terpolymer, ethylene-i-butyl methacrylate-silane terpolymer, ethylene-2-ethyl hexyl methacrylate-silane terpolymer, ethylene-isobornyl methacrylate-silane terpolymer, ethylene-pentyl methacrylate-silane terpolymer, ethylene-hexyl methacrylate-silane terpolymers or ethylene-octyl methacrylate-silane terpolymers and mixtures thereof. In some preferred embodiments, the monomers include, for example, methyl acrylate, ethyl acrylate, n-butyl acrylate, i-butyl acrylate, 2-ethyl hexyl acrylate, and mixtures thereof.

In some embodiments, when component (A) of the elastomeric polymer composition is at least one ethylene-alkyl (meth)acrylate-silane terpolymer; and the olefinic monomer portion of the terpolymer is an ethyl (meth)acrylate; the content of the olefinic monomer portion of the terpolymer, i.e., the ethyl (meth)acrylate content, can be from 1 wt % to 50 wt % in one general embodiment, from 5 wt % to 40 wt % in another embodiment, and from 10 wt % to 30 wt % in still another embodiment. The ethyl (meth)acrylate content of the terpolymer can be determined by proton nuclear magnetic resonance spectroscopy (¹H NMR). The ethyl (meth)acrylate can be determined by ¹H NMR spectroscopy or other analytical techniques known to those skilled in the art; such as analytical techniques described in Analytical Chemistry, Vol. 35, No. 12, pages 1948-1950, 1963.

In some embodiments, the content of the silane portion of the ethylene-olefinic monomer-silane terpolymer can be from 0.1 wt % to 2.5 wt % in one general embodiment, from 0.5 wt % to 2.0 wt % in another embodiment, and from 0.8 wt % to 1.5 wt % in still another embodiment. The silane content of the terpolymer can be determined by nuclear magnetic resonance (NMR) or by neutron activation analysis (NAA).

In some embodiments, the ethylene-olefinic monomer-silane terpolymer, component (A), of the elastomeric polymer composition used in the present invention has a melt index of from 0.1 g/10 min to 10.0 g/10 min in one general embodiment, from 0.5 g/10 min to 5 g/10 min in another embodiment, and from 1.0 g/10 min to 2.5 g/10 min in still another embodiment. The melt index (MI) of the terpolymer can be determined by the method described in ASTM D1238. The MI measurement of the ethylene-olefinic monomer-silane polymers used in the present invention provides an indication of the processability and physical properties of the compound; and in one preferred general embodiment, the terpolymer's melt index is in the range of from 0.1 g/10 min to 10.0 g/10 min.

In some embodiments, the ethylene-olefinic monomer-silane terpolymer, component (A), of the elastomeric polymer composition used in the present invention has an enthalpy of fusion of less than 85 J/g in one general embodiment, from 0.1 J/g to 70 J/g in another embodiment, from 1.0 J/g to 60 J/g in still another embodiment, and from 1.0 J/g to 50 J/g in yet another embodiment. The enthalpy of fusion of the terpolymer can be determined by the method described in ASTM D3418. The enthalpy of fusion measurement of the ethylene-olefinic monomer-silane polymers used in the present invention provides a measurement for the crystallinity of the polymer. Maintaining the terpolymer's enthalpy of fusion range to less than 85 J/g ensures the polymer has a sufficiently low crystallinity to, in turn, provide a sufficiently low compression set for the desired sealing performance of the polymer.

In one general embodiment, the concentration of the ethylene-olefinic monomer-silane terpolymer, component (A), useful for preparing the elastomeric polymer composition can be in the range of from 20 wt % to 99 wt %, based on the total weight of all components in the composition; from 35 wt % to 95 wt % in another embodiment, and from 50 wt % to 90 wt % in still another embodiment.

Component (B) of the elastomeric polymer composition is at least one curing catalyst that advances moisture-curing and/or thermo-curing of the elastomeric polymer composition. For example, the catalyst can be selected from acids such as Lewis acids, Bronsted acids, and mixtures thereof. Bases may also be used as a catalyst. In a preferred embodiment, component (B), can include, for example, dibutyltin dilaurate, sulfonic acid, and mixtures thereof. Some examples of Lewis acids that can be used in the practice of the present invention include, but are not limited to, tin carboxylates, such as dibutyl tin dilaurate, dimethyl hydroxy tin oleate, dioctyl tin maleate, di-n-butyl tin maleate, dibutyl tin diacetate, dibutyl tin dioctoate, stannous acetate, stannous octoate, and various other organo-metal compounds such as various titanates, lead naphthenate, zinc caprylate and cobalt naphthenate; and mixtures thereof.

Examples of suitable Bronsted acid catalysts useful in the present invention include, but are not limited to, monosulfonic acids and disulfonic acids; and mixtures thereof. Sulfonic acids are organic acids that contain one or more sulfonic (i.e., —SO₃H) groups, and have the general formula RS(═O)₂—OH, where R is an organic alkyl or aryl or substituted aryl group and the S(═O)₂—OH group is a sulfonyl hydroxide. Sulfonic acids can be aliphatic or aromatic and differ significantly in melting points. Examples of aromatic sulfonic acids are benzene sulfonic acid, alkyl benzene sulfonic acid, alkyl ethyl benzene sulfonic acid, alkyl toluene sulfonic acid, dodecylbenzenesulfonic acid, 4-methylbenzene sulfonic acid (also known as p-toluenesulfonic acid), alkyl xylene sulfonic acid, naphthalene sulfonic acid, alkyl naphthalene sulfonic acid, and blocked sulfonic acids; and mixtures thereof. Sulfonic acids include, for example, the silanol condensation catalysts disclosed in U.S. Pat. No. 8,460,770B2.

In other embodiments, the silanol condensation catalyst can be a blocked sulfonic acid. Blocked sulfonic acids can be amine-blocked (which are ionic, charged species) or covalently-blocked (through reactions with alcohols, epoxies, or functional polymers). Blocked sulfonic acids dissociate at elevated temperatures by hydrolysis, alcoholysis or decomposition reactions to generate free acids. More information on blocked sulfonic acids is presented in “Coatings Materials and Surface Coatings” (CRC Press, Nov. 7, 2006; edited by Arthur A. Tracton) and “Handbook of Coating Additives” (CRC Press, May 26, 2004; edited by John J. Florio, Daniel J. Miller). The NACURE™ materials (all products of King Industries) disclosed in U.S. Patent Application Publication No. 2011/0171570 are examples of blocked sulfonic acids with varying dissociation temperatures. Examples of commercially available blocked sulfonic acids include NACURE™ 1419 (product of King Industries), which is a 30% solution of covalently-blocked dinonylnaphthalenesulfonic acid in xylene/4-methyl-2-pentanone, and NACURE™ 5414 (product of King Industries), which is a 25% solution of covalently-blocked dodecylbenzenesulfonic acid in xylene.

In various embodiments of the present invention, a combination of two or more acidic silanol condensation catalysts may be employed. In one or more embodiments, the acidic silanol condensation catalyst can be selected from the group consisting of alkyl aromatic sulfonic acids, hydrolyzable precursors of alkyl aromatic sulfonic acids, organic phosphonic acids, hydrolyzable precursors of organic phosphonic acids, halogen acids, and mixtures of two or more thereof. In other embodiments, the acidic silanol condensation catalyst comprises an alkyl aromatic sulfonic acid. Examples of commercially available alkyl aromatic sulfonic acids include NACURE™ CD-2180 and NACURE™ B201 (available from King Industries, Norwalk, Conn., USA), and ARISTONIC™ Acid 9900 (available from Pilot Chemical Company, Cincinnati, Ohio, USA). In another preferred embodiment, component (B) of the elastomeric polymer composition useful in the present invention comprises, consists essentially of, or consists of, for example, dibutyltin dilaurate masterbatch, or sulfonic acid masterbatch and mixtures thereof.

The concentration of the curing catalyst, component (B), useful in preparing the elastomeric polymer composition can be from 0.1 wt % to 10 wt %, based on the total weight of all components in the composition, in one general embodiment; from 0.25 wt % to 5 wt % in another embodiment; and from 0.5 wt % to 2.5 wt % in still another embodiment.

The combination of components (A) and (B) forming the resultant elastomeric polymer composition useful in the present invention provides an elastomeric polymer composition that is capable of being cured using moisture and/or using heat. While not being limited to any one particular theory, it is found that the silane functional group of the elastomeric polymer composition, useful for making a profile or article of the present invention, will be cured using moisture and/or using heat.

Optionally, the elastomeric polymer composition may be formulated with a wide variety of additives to enable performance of specific functions while maintaining the excellent benefits/properties of the elastomeric polymer composition. For example, the optional additives, component (C), useful in the elastomeric polymer composition may be selected from the group consisting of colorants; carbon black; mineral fillers; process oils; flame retardants; foaming agents; process aids; antioxidants; UV light stabilizer; scorch retardant additives; and mixtures thereof.

In other embodiments, the optional additives added to the elastomeric polymer composition can include one or more polymeric components of polypropylene, polyethylene, thermoplastic vulcanizates, ethylene propylene diene monomer, ethyl vinyl acetate, and mixtures thereof.

The optional compounds, when used in preparing the elastomeric polymer composition, can be present in an amount generally in the range of from 0 wt % to 50 wt % in one embodiment; from 0.01 wt % to 40 wt % in another embodiment; and from 0.1 wt % to 30 wt % in still another embodiment.

In another broad embodiment, the process for making a profile or article using a moisture-curable and/or thermo-curable elastomeric polymer composition or formulation includes mixing, admixing, or blending: (A) at least one ethylene-olefinic monomer-silane polymer; wherein the at least one ethylene-olefinic monomer-silane polymer has: (i) an olefinic monomer content of from 1 wt % to 50 wt %; (ii) a silane content of from 0.1 wt % to 2.5 wt %; and (iii) a melt index of from 0.1 g/10 min to 10.0 g/10 min; and (B) at least one silanol condensation catalyst. One or more additional optional components, component (C), may be added to the elastomeric polymer composition, if desired. If desired, the optional additives, component (C), can be mixed with any one of the components (A) and (B) or both components (A) and (B). The order of mixing of the components is not critical; and two or more components can be mixed together followed by addition of the remaining components. The formulation components may be mixed together by any conventional mixing process and equipment as known to those skilled in the art of mixing.

In other embodiments, the process for making a profile or article using the moisture-curable or thermo-curable elastomeric polymer composition includes the steps of:
(I) weighing the following components: (A) at least one ethylene-olefinic monomer-silane polymer and (B) a curing catalyst, to provide the proper amount of components (A) and (B);
(II) mixing or compounding the components of step (I) forming a curable, reactive mixture elastomeric polymer composition which can be cured by moisture or by heat/temperature; and
(III) forming the resultant moisture-curable and/or thermo-curable elastomeric polymer composition from step (II) into a shape of an uncured finished part or article; and
(IV) curing the shaped uncured finished part or article from step (III) by exposing the formed/uncured part or article to humidity and/or heat to form a cured finished part or article.

In some embodiments, the at least one ethylene-olefinic monomer-silane polymer, component (A) useful in the above process, has an olefinic monomer content of from 5 wt % to 50 wt % and a silane content of from 0.1 wt % to 2.5 wt %; and the at least one ethylene-olefinic monomer-silane polymer has a melt index of from 0.1 g/10 min to 10.0 g/10 min.

In some embodiments, the curing catalyst, component (B) useful in the above process, can be at least one silanol condensation catalyst to form the reactive mixture elastomeric polymer composition.

The moisture-curable and/or thermo-curable elastomeric polymer composition produced by the methods described above, has several advantageous properties and/or benefits compared to known elastomeric polymer compositions. For example, some of the properties/benefits exhibited by the elastomeric polymer composition useful for making the profile or article of the present invention can include, for example: (1) the elastomeric polymer composition can be cured with moisture at ambient conditions or at elevated temperature in a moisture controlled environment such as a hot water bath or sauna; (2) the moisture cured elastomeric polymer composition will have much lower density versus an EPDM compound, and (3) the moisture cured elastomeric polymer composition will have better long-term heat resistance, better superior weatherability, better compression set, and improved NVH than a conventional elastomeric polymer composition.

The elastomeric polymer composition useful in the present invention can be used, for example, in automotive applications, for example to fabricate various auto profiles, parts or articles including, for example, weather seals, flexible hoses (e.g., fabric reinforced hoses), coextruded multilayer tubes, belts, or profile products.

The automotive weather seal generally consists of a low-density sponge profile co-extruded onto a dense profile with metal carrier, as attachment to the door and car body. These automotive weather seals (door mounted seal and body mounted seal) contribute to the comfort inside the car by providing insulation from water, vibration, and aerodynamic noises. The geometry of the sponge profile has become increasingly complex over the years to improve overall sealing performance. A typical manufacturing process of automotive weather seal includes the following steps: formulating and mixing, profile extrusion, curing and foaming; surface coating if necessary, cutting and shaping, connecting the final assembly and then finishing, packing and shipping.

The typical construction of a flexible hose consists of inner tube layer, reinforcement layer, and outer cover layer. The first layer is an inner tube that carries the material being transported. The thickness of the inner tube depends on the intended service. The next layer is called the reinforcement layer, which consists of metal (mesh or wire), synthetic polymer, and/or textile covering (or combinations of these materials) that enables the hose to withstand internal and external pressure and abuse. Reinforcement fabrics commonly used include cotton, glass fiber, aramid fibers (such as Kevlar® and Nomex® brands), nylon, polyester, and rayon. The outer cover layer protects the reinforcement from damage caused by exposure to the environment, fluid contamination, and physical abuse. A flexible hose must be flexible to accommodate misalignment, ease of routing and installation, motion, portability, thermal expansion, and vibration.

In one broad embodiment, the method for manufacturing weather seals, hoses (e.g., fabric reinforced hoses), coextruded multilayer tubes, belts, or profile products includes the steps of: (I) mixing or compounding: (A) at least one ethylene-olefinic monomer-silane terpolymer; wherein the at least one ethylene-olefinic monomer-silane terpolymer has a composition of an olefinic monomer content of from 5 wt % to 50 wt % and a silane content of from 0.1 wt % to 2.5 wt %; and wherein the at least one ethylene-olefinic monomer-silane terpolymer has a melt index of from 0.1 g/10 min to 10.0 g/10 min; and (B) at least one silanol condensation catalyst to form a reactive mixture composition; (II) forming the reactive mixture composition from step (I) into a shape of a finished part or article; and (III) curing the finished part or article from step (II) by exposing the fabricated part or article from step (II) to humidity and/or heat to form a cured finish part or article.

The conditions for mixing or compounding the components of the composition, step (I) include, for example, the mixing can be carried out at a temperature of from 85° C. to 225° C. with traditional mixing or compounding equipment, for example, a roll mill, an internal mixer, a single-screw extruder, or a twin-screw compounding extruder.

The process conditions for running step (II) of the above method, i.e., forming the reactive mixture composition from step (I) into a shape of a finished part or article include, for example, carrying step (II) at a temperature of from 85° C. to 225° C. with traditional polymer fabrication equipment, for example, a single-screw extruder, a twin-screw extruder, a coextrusion line, an injection molding machine, and a calendaring machine.

In the above process, step (I) and step (II) can be combined into one step to achieve both mixing of the components (A) at least one ethylene-olefinic monomer-silane terpolymer and (B) at least one silanol condensation catalyst; and forming the reactive mixture composition from step (I) into a shape of a finished part or article.

In carrying out the curing step, step (III) of the above process, the conditions for curing the formed uncured part or article from step (II) include, for example, the conditions for curing by moisture at ambient temperature and at ambient moisture content/humidity level, or at elevated temperature and/or elevated humidity, including for example, the use of a water bath. For example, curing by moisture can be carried out at a temperature of from 0° C. to 100° C. in one general embodiment; from 15° C. to 90° C. in another embodiment; and from 25° C. to 40° C. in still another embodiment. The moisture content/humidity level of curing can be from 0% to 100% in one general embodiment; from 20% to 80% in another embodiment; and from 40% to 80% in still another embodiment.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of the compositions described herein. Unless otherwise stated all parts and percentages are by weight on a total weight basis.

### Designations

Some of the designations and abbreviations used for some of the materials and items used in the Examples are as follows:
“VTMS” stands for vinyltrimethoxysilane.
“E/EA/VTMS” stands for ethylene/ethyl acrylate/vinyltrimethoxysilane terpolymer.
“E/VTMS” stands for ethylene/vinyltrimethoxysilane copolymer.
“DPTT” stands for dipentamethylene thiuram tetrasulfide.
“TMTD” stands for tetramethylthiuram disulfide.
“ZDBC” stands for zinc dibutyldithiocarbamate.
“MBT” stands for mercaptobenzthiazol.
“MBTS” stands for mercaptobenzthiazol disulfide.

The term “bleeding oil” used in the Tables described in the Examples, with reference to a plasticizer oil, means an excessive amount of plasticizer oil migrating to the surface of fully formulated parts formed from the above-described moisture- and/or thermo-curable elastomeric polymer composition after a few days of storage time.

### Raw Materials (Ingredients)

The pertinent raw materials (products or ingredients) used in the Examples are described in Table I. The catalyst used in the Examples and described in the following tables is a masterbatch of a concentrate of 1.5 wt % aromatic sulfonic acid and 5 wt % antioxidants in polyethylene (available from The Dow Chemical Company).

TABLE I
Raw Materials

| Product | Brief Description of Product | Supplier |
|---|---|---|
| Carbon Black, N550 | Carbon black used as a reinforcing filler | Cabot |
| SUNPAR 2280 | Plasticizer/paraffinic oil | Holly Frontier |
| Hubercarb W3N | Calcium carbonate | Huber |
| Mistron ® Vapor RE | Talc | IMCD |
| ZnO (Zinkoxyd aktiv ®) | Zinc oxide | Lanxess |
| Stearic Acid F-1500 | Carboxylic acid | Harwick Standard |
| PEG 4000 | Polyethylene glycol 4,000 average molecular weight | Harwick Standard |
| AO 405 | 4,4′-Bis(α,α-dimethylbenzyl) diphenylamine | Akrochem |
| AO 60 | Methyl mercapto benzimidazole | Akrochem |
| CaO Dispersion | CaO dispersion (95%) | Harwick Standard |
| Rhenogran ® S80 | 80% dispersion of sulfur | RheinChemie |
| Rhenogran ® DPTT-70 | Dipentamethylene thiuram tetrasulfide | RheinChemie |
| Rhenogran ® TMTD-75 | Tetramethylthiuram disulfide | RheinChemie |
| Rhenogran ® ZDBC-80 | Zinc dibutyldithiocarbamate | RheinChemie |
| Rhenogran ® MBT-80 | Mercaptobenzthiazol | RheinChemie |
| Rhenogran ® MBTS-70 | Mercaptobenzthiazol disulfide | RheinChemie |

### Polymers

The polymers used in the Examples are EPDM rubbers, polyolefin elastomers, E/VTMS copolymers and E/EA/VTMS terpolymers. The characteristics of these polymers are described in Table II and Table III, collectively. In addition, the E/VTMS copolymer used in the Examples has a density of 0.922 g/cc and a melt index (2.16 kg; 190° C.) of 1.5 g/10 min.

TABLE II
EPDM Rubber and Polyolefin Elastomer

| | Brief Description | |
|---|---|---|
| Product | of Product | Supplier |
| NORDEL ™ 6565 XFC | EPDM rubber | The Dow Chemical |
| | | Company (Dow) |
| NORDEL ™ 4770 | EPDM rubber | Dow |
| ENGAGE ™ 8842 | Polyolefin elastomer | Dow |

TABLE III
Characteristics of E/EA/VTMS Terpolymers
and E/VTMS Copolymer

| | Composi- | | | | |
|---|---|---|---|---|---|
| | tion | Monomer Content | | | Enthalpy |
| | Compo- | (wt %) | | MI | of Fusion |
| Compound | nent | VTMS | EA/nBA | (dg/min) | (J/g)* |
| E/VTMS | A | 1.5 | — | 1.5 | 143.0 |
| copolymer | | | | | |
| E/EA/VTMS | A | 1.2 | 26.0 | 45.8 | 69.6 |
| terpolymer 1 | | | | | |
| E/EA/VTMS | A | 1.0 | 21.0 | 1.5 | 82.6 |
| terpolymer 2 | | | | | |
| E/EA/VTMS | A | 1.3 | 6.5 | 1.8 | 122.0 |
| terpolymer 3 | | | | | |
| E/nBA/VTMS | A | 1.5 | 41.4 | 20.1 | 31.2 |
| terpolymer 4 | | | | | |

*The Enthalpy of Fusion measurement, in J/g, is the value integrated from −40° C. to the end temperature (about 150° C.) of DSC heating curve.

Enthalpy of Fusion vs. Compression Set Measurements

A curable polymer formulation is prepared by mixing polymer, carbon black, paraffinic oil, and peroxide curing agents. The mixing, formulation and testing used to measure the above formulation is illustrated in Table 2 of “NORDEL™ EPDM product selection guide” published October 2018 by The Dow Chemical Company. The enthalpy of fusion of the polymer used in the formulation is measured independently. Once the polymer formulation is cured, the compression set of the cured polymer formulation is measured. The results of the measurements are described in Table IV.

TABLE IV
Enthalpy of Fusion vs. Compression Set

| | Enthalpy of Fusion | Compression Set |
|---|---|---|
| | of Polymer | of Cured Polymer |
| Polymer | (J/g)* | (22 hr @70° C.) |
| Nordel 5565 | 1 | 6 |
| Nordel 4520 | 2 | 9 |
| Nordel 4570 | 3 | 8 |
| Nordel 4640 | 9 | 8 |
| Nordel 4760 | 28 | 9 |
| Nordel 4785 | 33 | 9 |
| Nordel 3745 | 41 | 21 |
| Nordel 3722 | 42 | 29 |
| Nordel 3720 | 50 | 30 |
| Nordel 4820 | 85 | 75 |
| E/EA/VTMS terpolymer 3 | 120 | 90 |

*The Enthalpy of Fusion measurement, in J/g, is the value integrated from −40° C. to the end temperature (about 150° C.) of DSC heating curve.

### E/EA/VTMS or E/BA/VTMS Terpolymers Production/Polymerization Procedure

The solution used to prepare the acrylate/VTMS terpolymers was a peroxide initiator tert-butyl peroctoate (TBPO, 1% by weight solution in odorless mineral spirits). A vessel (reactor) used in preparing the polymerization procedure was sparged with nitrogen for 5 min before use, and kept under a nitrogen pad during operation. The typical polymerization conditions used in the preparation method and the exact details for each run are described in Table V below. The reactor used was a 545-mL high pressure continuous stirred tank reactor (CSTR), with an external heating jacket to minimize CSTR heat loss to the environment.

A stream of ethylene was injected, under the reactor conditions described below, into the CSTR agitated at 2,200 rpm. Ethyl acrylate, VTMS, and propylene functioning as a chain transfer agent (CTA) were separately added to the ethylene stream at a pressure of 62 bar; and the propylene CTA was controlled at a rate to produce a range of final products. The TBPO initiator solution was added directly to the CSTR, through the sidewall, at a pressure of 1,930 bar at a rate to control the internal temperature of the CSTR at 220° C.

TABLE V
Conditions for E/EA/VTMS Terpolymer Synthesis

| | Reactor | Reactor | Reactor | | | | | Adjusted | |
|---|---|---|---|---|---|---|---|---|---|
| | Control | Control | Feed | Ethylene | Acrylate | VTMS | Propylene | TBPO | Polymer |
| | Pressure | Temp.* | Temp. | Flow | Flow | Flow | Flow | Flow | Collected |
| Material | (kPa) | (° C.) | (° C.) | (kg/hr) | (kg/hr) | (kg/hr) | (kg/hr) | (cc/hr) | (g) |
| E/EA/VTMS | 193,000 | 220 | 60.31 | 11.3 | 0.513 | 0.082 | 0.26 | 0.34 | 8.5 |
| terpolymer 1 | | | | | | | | | |
| E/EA/VTMS | 193,000 | 220 | 60.41 | 11.3 | 0.490 | 0.068 | 0.00 | 0.26 | 22.2 |
| terpolymer 2 | | | | | | | | | |
| E/EA/VTMS | 193,000 | 220 | 59.91 | 11.3 | 0.136 | 0.064 | 0.23 | 0.34 | 5.1 |
| terpolymer 3 | | | | | | | | | |
| E/BA/VTMS | 193,000 | 220 | 60.35 | 11.3 | 1.03 | 0.082 | 0.018 | 0.21 | 20.2 |
| terpolymer 4 | | | | | | | | | |

*“Temp” = “temperature”

Quantification of ethyl acrylate was conducted by nuclear magnetic resonance (1H NMR). Each ¹H NMR sample was prepared by adding ˜0.1 g to 0.2 g of sample to 3.25 g of 50/50 by weight 1,1,2,2-tetrachlorethane-d2/perchloroethylene (TCE/PCE) containing 0.001 M Cr(AcAc)3 and about 75 ppm butylated hydroxytoluene (BHT), in a Norell 1001-7 10 mm NMR tube. The samples were purged by bubbling N2 through the solvent via a pipette inserted into the tube for approximately 3 min to remove oxygen, capped, sealed with Teflon tape and then heated and vortexed at 115° C. to dissolve and ensure homogeneity.

¹H NMR was performed on a Bruker AVANCE 600 MHz spectrometer equipped with a Bruker high-temperature CryoProbe at a sample temperature of 120° C. Spectra were acquired with ZG pulse, 2 s AQ, 16 scans with a relaxation delay of 20 s.

### Formulations

The formulations comprising the moisture-curable and/or thermo-curable elastomeric polymer composition of the Examples are described in Table VI (Comp. Ex.) and Table VII (Inv. Ex.). The catalyst used in the Examples and described in the following tables is a masterbatch of a concentrate of 1.5 wt % aromatic sulfonic acid and 5 wt % antioxidants in polyethylene (available from The Dow Chemical Company)

TABLE VI
Formulations of Comparative Examples

| | Example No. | | | | | |
|---|---|---|---|---|---|---|
| | Comp. | Comp. | Comp. | Comp. | Comp. | Comp. |
| | Ex. A | Ex. B | Ex. C | Ex. D | Ex. E | Ex. F |
| Material | (phr) | (phr) | (phr) | (phr) | (phr) | (phr) |
| NORDEL ™ 6565 XFC | 80 | | | | | |
| NORDEL ™ 4770 | 20 | | | | | |
| Carbon Black, N550 | 136 | 50 | 50 | 51.5 | 50.8 | 50.3 |
| Hubercarb W3N | 60 | | | | | |
| Mistron ® Vapor RE | 20 | | | | | |
| Zno (Zinkoxyd aktiv) | 6 | | | | | |
| Stearic Acid F-1500 | 1 | | | | | |
| PEG 4000 | 2 | | | | | |
| SUNPAR 2280 | 90 | 40 | 40 | 41.2 | 40.6 | 40.2 |
| AO405 | 1 | | | | | |
| AO 60 | 2 | | | | | |
| CaO Dispersion (95%) | 5.00 | | | | | |
| Rhenogran ® S80 | 1.25 | | | | | |
| Rhenogran ® DPTT-70 | 1.50 | | | | | |
| Rhenogran ® TMTD-75 | 0.90 | | | | | |
| Rhenogran ® ZDBC-80 | 0.20 | | | | | |
| Rhenogran ® MBT-80 | 0.30 | | | | | |
| Rhenogran ® MBTS-70 | 1.00 | | | | | |
| E/VTMS copolymer | | 100 | 80 | | | |
| E/EA/VTMS terpolymer 1 | | | | 79 | 79 | 79 |
| E/EA/VTMS terpolymer 2 | | | | | | |
| ENGAGE ™ 8842 | | | 20 | 21 | 21 | 21 |
| Catalyst | | 1 | 1 | 3.1 | 1.5 | 0.5 |
| Grand Total | 428.2 | 191 | 191 | 195.9 | 192.9 | 191 |

TABLE VII
Formulations of Inventive Examples

| | Example No. | | | | |
|---|---|---|---|---|---|
| | Inv. Ex. | Inv. Ex. | Inv. Ex. | Inv. Ex. | Inv. Ex. |
| | 1 | 2 | 3 | 4 | 5 |
| Material | (phr) | (phr) | (phr) | (phr) | (phr) |
| NORDEL ™ 6565 XFC | | | | | |
| NORDEL ™ 4770 | | | | | |
| Carbon Black, N550 | 50 | 50 | 50 | 3 | 3 |
| Hubercarb W3N | | | | | |
| Mistron ® Vapor RE | | | | | |
| Zno (Zinkoxyd aktiv) | | | | | |
| Stearic Acid F-1500 | | | | | |
| PEG 4000 | | | | | |
| SUNPAR 2280 | 40 | 40 | 40 | 8 | 8 |
| AO405 | | | | | |
| AO 60 | | | | | |
| CaO Dispersion (95%) | | | | | |
| Rhenogran ® S80 | | | | | |
| Rhenogran ® DPTT-70 | | | | | |
| Rhenogran ® TMTD-75 | | | | | |
| Rhenogran ® ZDBC-80 | | | | | |
| Rhenogran ® MBT-80 | | | | | |
| Rhenogran ® MBTS-70 | | | | | |
| E/VTMS copolymer | | | | | |
| E/EA/VTMS | | | | | |
| terpolymer 1 | | | | | |
| E/EA/VTMS | 100 | 80 | 50 | 100 | 80 |
| terpolymer 2 | | | | | |
| ENGAGE ™ 8842 | | 20 | 50 | | 20 |
| Catalyst | 1 | 1 | 1 | 1 | 1 |
| Grand Total | 191 | 191 | 191 | 112 | 112 |

### General Process for Mixing Compounds

The compounds were mixed in a Brabender or a Banbury internal mixer using a standard “upside-down” mixing procedure, adding carbon black and oil first and then adding the polymer (EPDM rubber or E/EA/VTMS terpolymers) last. The mixing conditions were as follows: fill factor, which is the ratio of the volume of the mixing material to the volume of the mixing chamber, was set at 75%; rotor speed was kept constant at 50 rpm during the mixing cycle; mixer body temperature was set at 60 degrees Celsius. The samples were discharged from the mixer when the mixture temperature reached 115° C.

### Compression Molded Plaques and Moisture Curing

Samples from the well mixed and uncured compound mixture above were cut, and then molded in a compression molder at 130° C. to make test specimens. Each of the molded test specimens was a plaque 15.24 cm wide by 15.24 cm long and 2 mm thick.

To vulcanize the plaque samples made with the terpolymers, the molded plaque samples were placed in a water bath and kept in the bath at 60° C. for 24 hr.

To vulcanize the plaque samples made with the EPDM rubbers, the molded plaque samples were placed in a hot press at 180° C. for 15 min.

### Testing Methods

### Tensile Strength and Elongation Tests

The physical properties of the above vulcanized samples were measured according to the procedure described in ASTM D412.

### Compression Set

Compression set of all vulcanized samples was measured at 23° C. for 22 hr, according to the procedure described in ASTM D395 (25% deflection method B).

### Hardness

Shore A type hardness was measured according to the procedure described in ASTM D2240 using a 3-layer ply of vulcanized sample plaques.

### Results

The results of testing the vulcanized plaque samples using the above-described testing methods are described in Table VIII (Comp. Ex.) and Table IX (Inv. Ex.).

TABLE VIII
Results for Comparative Examples

| | Example No. | | | | | |
|---|---|---|---|---|---|---|
| | Comp. | Comp. | Comp. | Comp. | Comp. | Comp. |
| Property | Ex. A | Ex. B | Ex. C | Ex. D | Ex. E | Ex. F |
| Shore A Hardness (70 ± 5): | 72 | | | 69.90 | 70.10 | 68.90 |
| Tensile Strength (8 Mpa Min): | 11 | | | 1.99 | 2.46 | 2.09 |
| Elongation (250% Min): | 464 | | | 268.41 | 338.27 | 319.78 |
| Compression Set (@RT for 22 hr): | | | | 48.80 | 47.30 | 45.80 |
| Oil: | | BO* | BO | No BO | No BO | No BO |

*BO stands for “bleeding oil.”

TABLE IX
Results for Inventive Examples

| | Example No. | | | | |
|---|---|---|---|---|---|
| | Inv. Ex. | Inv. Ex. | Inv. Ex. | Inv. Ex. | Inv. Ex. |
| Property | 1 | 2 | 3 | 4 | 5 |
| Shore A Hardness: | 80.4 | 77.1 | 73 | 82.5 | 77.8 |
| Tensile Strength: | 8.57 | 7.58 | 6.8 | 15.88 | 15.54 |
| Elongation: | 746.55 | 683.88 | 803.26 | 941.3 | 904.8 |
| Compression Set | 35.0 | 33.0 | 40.0 | 28.0 | 29.0 |
| (@RT for 22 hr): | | | | | |
| Oil: | No BO* | No BO | No BO | No BO | No BO |

*BO stands for “bleeding oil.”

### Other Embodiments

In one embodiment, the method of the present invention wherein the content of the olefinic monomer of the ethylene-olefinic monomer-silane polymer is from 5 weight percent to 50 weight percent; and wherein the content of the silane content of the ethylene-olefinic monomer-silane polymer is of from 0.1 weight percent to 2.5 weight percent.

In another embodiment, the method of the present invention wherein step (II) of forming the reactive mixture composition comprises extruding the at least one ethylene-olefinic monomer-silane polymer and the silanol condensation catalyst from step (I) into a shape of a finished part or article.

In another embodiment, the method of the present invention wherein the step of mixing or compounding is carried out using mixing or compounding equipment selected from the group consisting of a roll mill, an internal mixer, a single-screw extruder, a twin-screw compounding extruder, and a combination thereof.

In another embodiment, the method of the present invention wherein the reactive mixture composition of step (II) is formed into the shape of a finished part or article selected from the group consisting of a weather seal, a hose, a belt, and a profile article.

In another embodiment, the method of the present invention, wherein the finished part or article is an automobile weather seal, automobile weather seal, an automobile hose, an automobile belt, or an automobile profile article.

In another embodiment, the article of the present invention wherein the content of the olefinic monomer of the ethylene-olefinic monomer-silane polymer is from 5 weight percent to 50 weight percent; and wherein the content of the silane content of the ethylene-olefinic monomer-silane polymer is of from 0.1 weight percent to 2.5 weight percent.

What is claimed is:

1. A profile or article formed from a moisture-curable and/or thermo-curable elastomeric polymer composition comprising:
(A) at least one ethylene-olefinic monomer-silane polymer; wherein the polymer has a melt index of from 0.1 gram/10 minutes to 10.0 grams/10 minutes; and wherein the polymer has an enthalpy of fusion of less than 85 J/g; and
(B) at least one silanol condensation catalyst.

2. The article of claim 1, wherein the article formed is at least one or more of: a weather seal, a hose, or a belt.

3. The article of claim 1, wherein the at least one ethylene-olefinic monomer-silane polymer is a terpolymer or a tetrapolymer.

4. The article of claim 3, wherein the at least one ethylene-olefinic monomer-silane polymer is an ethylene-olefinic monomer-silane terpolymer.

5. The article of claim 4, wherein the content of the olefinic monomer of the ethylene-olefinic monomer-silane terpolymer is from 5 weight percent to 50 weight percent; and wherein the content of the silane content of the ethylene-olefinic monomer-silane terpolymer is of from 0.1 weight percent to 2.5 weight percent.

6. The article of claim 5, wherein the concentration of the at least one ethylene-olefinic monomer-silane terpolymer is from 20 weight-percent to 99 weight-percent, based on the total weight of all components in the composition; and wherein the concentration of the at least one silanol condensation catalyst is from 0.1 weight-percent to 10 weight-percent based on the total weight of all components in the composition.

7. The article of claim 4, wherein the at least one ethylene-olefinic monomer-silane terpolymer is at least one ethylene-alkyl (meth)acrylate-silane terpolymer.

8. The article of claim 7, wherein the at least one ethylene-alkyl (meth)acrylate-silane terpolymer is selected from the group consisting of at least one ethylene-ethyl acrylate-silane terpolymer; at least one ethylene-butyl acrylate-silane terpolymer; and mixtures thereof.

9. The article of claim 1, comprising further including one or more additive selected from the group consisting of colorants, mineral fillers, process oils, flame retardants, foaming agents, process aids, antioxidants, and mixtures thereof.

10. The article of claim 1, comprising further including one or more polymeric components of polypropylene, polyethylene, thermoplastic vulcanizates, ethylene propylene diene monomer, ethyl vinyl acetate, and mixtures thereof.

11. A method for manufacturing a weather seal, hose, or belt product comprising the steps of:
(I) mixing or compounding:
(A) at least one ethylene-olefinic monomer-silane polymer; wherein the polymer has a melt index of from 0.1 gram/10 minutes to 10.0 grams/10 minutes; and wherein the polymer has an enthalpy of fusion of less than 85 J/g; and
(B) at least one silanol condensation catalyst;
(II) forming the reactive mixture composition from step (I) into a shape of a finished part or article; and
(III) curing the finished part or article from step (II) by exposing the finished part or article from step (II) to humidity and/or heat to form a cured finish part or article.

12. An article comprising a weather seal, a hose, a belt, or profile article prepared using a moisture- and/or thermo-curable elastomeric polymer composition comprising:
(A) at least one ethylene-olefinic monomer-silane polymer; wherein the terpolymer has a melt index of from 0.1 gram/10 minutes to 10.0 grams/10 minutes; and wherein the terpolymer has an enthalpy of fusion of less than 85 J/g; and
(B) at least one silanol condensation catalyst.
